(19) United States
(12) Patent Application Publication
(10) Pub. No.: US 2011/0313593 A1
(43) Pub. Date: Dec. 22, 2011

(54) Vehicle On Board Diagnostic Port Device with GPS Tracking, Auto-Upload, and Remote Manipulation

(76) Inventors: Meir S. Cohen, Toms River, NJ (US); Eli Finkelman, Toms River, NJ (US)

(21) Appl. No.: 12/819,665

(22) Filed: Jun. 21, 2010

(51) Int. Cl. G06F 19/00; G01S 19/42

(52) U.S. Cl. 701/2; 701/33

(57) ABSTRACT

A device of embodiments of the disclosed technology comprises an interface adapted for engagement with an on-board diagnostic port of a vehicle, a global navigation satellite system receiver, a data storage device for storing received global navigation system data from the global navigation satellite system receiver, and a wireless network adapter. The network adapter is capable of sending, receiving, and interpreting data signals transmitted wirelessly to a network, such as an at home network and/or 802.11 wireless network. Such a wireless network adapter may be configured to seek out available wireless networks and send data stored in the data storage device to a remote server upon connection to the wireless network. Such networks may be either unsecured networks and/or networks preprogrammed into the device, such as via configuration before placement into the vehicle.

### FIELD OF THE DISCLOSED TECHNOLOGY

The disclosed technology relates generally to global navigation satellite system receivers and, more specifically, to global navigation satellite system receivers with wireless network adapter for in-vehicle use.

### BACKGROUND OF THE DISCLOSED TECHNOLOGY

In-car GPS (global positioning system or other satellite navigation technology) is known in the art, as are GPS loggers. Based on a signal received from satellites revolving around the earth at known positions, the location of a receiver of such signals may be determined. Such location data may also be logged. GPS logging devices, such as those placed beneath a car, enable a user (or law enforcement agent) to track the location of a vehicle. In many such embodiments, the device has to be retrieved and the data downloaded. In other embodiments, the device has network connectivity and is a GPS tracker. GPS trackers enable offsite monitoring of the location of a vehicle in real time.

On-board diagnostic computers and ports are also known in the art. Generally, on-board diagnostics (herein, “OBD”) refers to a vehicle's self-diagnostic and reporting capability. The OBD system gathers information from a vehicle's engine control module (“ECM”) in order to provide diagnostic data. All modern vehicles are controlled by an ECM or on-board computer. Generally, an ECM ensures that the engine and transmission run efficiently, and that exhaust emissions are kept within the permitted ranges. The OBD system gives a vehicle owner or repair technician access to information regarding the status of various components of a vehicle. Originally, the OBD system simply illuminated a “check engine” light or similar when it detected a problem. More recently, vehicles have become equipped with a standardized fast digital communications port, not only to provide data from a vehicle's on-board computer, but to allow remedial data to be sent to the vehicle's on-board computer. The OBD systems have evolved and improved over the years. Currently, many different OBD interfaces are in existence; these include OBD-1, OBD-1.5, OBD-II, EOBD (Europe), EOBD2 (Enhanced), and JOBD (Japan). Most vehicles use the OBD-II interface which uses a standardized female 16-pin J1962 connector. Hand-held scanning devices are available ranging from simple consumer level tools to original equipment manufacturer (“OEM”) tools used by dealers and mechanics. The devices simply plug into the OBD port using a specialized male connector. The devices are capable of interacting with the vehicle's systems by way of its ECM.

While GPS loggers and GPS trackers have their uses, obvious downsides to each exist. GPS loggers do not provide real time data. Data can only be retrieved, such as by a third party, after the device itself is retrieved or accessed. This requires “manual labor” in that a person must take further action which may even involve getting beneath the vehicle again to retrieve the GPS logger. Needless to say, when tracking criminal activity, the least number of times one must access the vehicle, the better. Further, if data are required more frequently than it is possible or convenient to access the GPS logger device, it must be done by way of a GPS tracker.

GPS trackers, too, have their drawbacks. GPS trackers require network connectivity which is not always easy to come by and may be expensive. For example, a GPS tracker may need its own connection to a cellular data network or a special license to operate on another frequency. The cost of power consumption for handling GPS tracking, storage, and constant or near-constant long range radio transmission, may also be prohibitive. The cost of such devices is also much higher than that of GPS loggers.

Still another problem exists, namely that of detection when either a GPS logger or tracker is used. The device may be undesirably discovered and the purpose of its use compromised. A suspected criminal under surveillance may discover the device, disable it, and take new measures to avoid law enforcement. A parent attempting to track the driving habits of his minor child also may need to hide his or her activities in GPS logging. Further, a person may make use of GPS tracking to find the location of his or her car in case it is stolen or misused by someone who has borrowed the car. In all of these cases, detection would likely put an end to the legal owner's being able to retrieve the data sought.

Thus, the prior art leaves room for improvement upon current tracking technologies. What is needed is a way to track movements of a vehicle regardless of whether or not the driver is aware that the vehicle is being tracked. Another need in the art is to have a way to track a position of a vehicle cheaply, that is, without requiring expensive or obscure network connectivity solutions, and with power consumption as low as possible. A further requirement is to enable users to have control over the physical functions of the particular vehicle they are tracking.

Likewise, communication with a vehicle through its on-board computer has its shortcomings. The state of the current technology only allows a user to receive signals through a vehicle's OBD port using a local diagnostic device. Furthermore, applications of many of the existing devices are limited to those which toggle a malfunction indicator lamp (i.e., a check-engine light) or an emissions setting within the vehicle's engine control module (i.e., ignition timing or fuel injection settings).

Accordingly, there exists the need for new and useful methods and devices for tracking and manipulating a vehicle's movement and functions. It is, therefore, to the effective resolution of the aforementioned problems and shortcomings of the prior art that the disclosed technology is directed

### SUMMARY OF THE DISCLOSED TECHNOLOGY

The disclosed technology described herein addresses an unfulfilled need in the prior art by providing a device and method for tracking a vehicle's movement and manipulating a vehicle's functions.

It is therefore an object of the disclosed technology to provide a cost-effective GPS tracking method.

It is a further object of the disclosed technology to seek out available wireless networks to send GPS information to a remote location.

It is yet another object of the disclosed technology to manipulate a vehicle's functions from a remote location by way of an on-board diagnostic port.

A transceiver device of embodiments of the disclosed technology comprises an interface adapted for engagement with an on-board diagnostic port of a vehicle, a global navigation satellite system receiver, a data storage device for storing received global navigation system data from the global navigation satellite system receiver, and a wireless network adapter. The network adapter is capable of sending, receiving, and interpreting data signals transmitted wirelessly to a network, such as an at home network and/or 802.11 wireless network (e.g., 802.11a, 802.11b, 802.11g, or 802.11n according to the standards drafted by the IEEE LAN/MAN standards committee and widely known in the art). Such a wireless network adapter may be configured to seek out available wireless networks and send data stored in the data storage device (e.g., coordinates mapped over time or video/audio data) to a remote server upon connection to the wireless network. Such networks may be either unsecured networks and/or networks pre-programmed into the device, such as via configuration before placement into the vehicle. Thus, in order to enable connection to a secure wireless local area network, authentication data may be stored on the device.

In another embodiment of the disclosed technology, the transceiver device may be used to manipulate a function of the vehicle through said on-board diagnostic port. The user sends command data to the device by way of the wireless local area network. The command data contain task information pertaining to specific make of the car. For instance, in an embodiment of the disclosed technology the user sends command data which toggles the functionality of the ignition system of the vehicle. In another embodiment of the disclosed technology the user sends command data which toggles the state of the door locks of the vehicle. The transceiver device translates these command data through the on-board diagnostic port to the vehicle's on-board computer.

In an embodiment of the disclosed technology the remote server is located on a wireless local area network. In another embodiment of the disclosed technology, the remote server is located on a wide area network. In this embodiment, data uploaded from the device is transmitted to the remote server through an open public packet switched network.

In yet another embodiment of the disclosed technology, the transceiver device may further have at least one sensory input device configured to record sensory information to the data storage device. That is, a microphone to record sound, a camera to record video, and/or a thermometer to record the temperature may be employed in the transceiver device, and such data may further be uploaded via a network to the server upon obtaining network connectivity.

A method of remotely communicating with a vehicle is also disclosed. The method is carried out by connecting a transceiver device to an on-board diagnostic port of a vehicle. The provided transceiver device is equipped with a global navigation satellite system receiver, a non-volatile storage device, a wireless network adapter, and a connector adapted for connection to an on-board diagnostic port of the vehicle. The transceiver device is instructed to receive global navigation system data using the global navigation satellite system receiver. The received global navigation system data is then stored on the storage device. Next, the device is configured to connect to any one of a plurality of wireless local area networks. Upon connection, the device uploads the data stored on the storage device to a remote server.

In a further embodiment of the aforementioned method, an additional step of manipulating a function of the vehicle using the transceiver device is disclosed. The function to be performed is sent to the device by way of the remote server. In one embodiment of the method of the disclosed technology, the function is the ignition system of the vehicle. In another embodiment of the method of the disclosed technology, the function is the door locks.

In the method of carrying out the disclosed technology, a step of receiving data from a sensory input device and storing the data on the data storage device may take place. Again, the sensory input device may be a microphone, camera, thermometer, or the like. In an embodiment in which the sensory device is a microphone, the sound data recorded from the microphone is stored on the provided storage device. Then, upon connection to wireless network, the sound data is uploaded to the remote server. Similarly, in an embodiment in which the sensory device is a camera, the video or image data recorded from the camera is stored on the provided storage device. Then, upon connection to the wireless network, the video or image data is uploaded to the remote server.

The transceiver device may further have a wireless network adapter and, in an additional step of the method, it may be configured to seek out an available wireless network and send data stored in the data storage device to a remote server upon connection to the wireless network. This may include seeking out unsecured (e.g., open, unencrypted, public access) 802.11 wireless networks, only wireless networks preprogrammed in the device, and the like. Should an 802.11 wireless network be a secure wireless network, authentication data for the given secure network may be stored on the device in order to enable connectivity.

In another embodiment of the disclosed technology, a transceiver device of embodiments of the disclosed technology comprises an interface adapted for engagement with an on-board diagnostic port of a vehicle, a global navigation satellite system receiver, a data storage device for storing received global navigation system data from the global navigation satellite system receiver, a sensory input device, and a wireless network adapter. The network adapter is capable of sending, receiving, and interpreting data signals transmitted wirelessly to a network. The sensory input device is configured to record to said data storage device sensory information from said vehicle. In this embodiment the type of sensory input information may include sound data, video data, temperature data, and vehicle diagnostic data.

### BRIEF DESCRIPTION OF THE DRAWINGS

FIG. 1 shows a high level drawing of a vehicle dashboard with an inset of an exemplary on-board diagnostic port.

FIG. 2 shows a high level drawing of a global navigation system and network devices used in embodiments of the disclosed technology.

FIG. 3 shows a high level schematic diagram of components within a transceiver device in an embodiment of the disclosed technology.

FIG. 4 is a flow chart of a method of carrying out embodiments of the disclosed technology relative to a transceiver device of embodiments of the disclosed technology.

FIG. 5 is a flow chart of a method of carrying out embodiments of the disclosed technology in which a user manipulates a function of a vehicle.

FIG. 6 shows a high-level block diagram of a device that may be used to carry out the disclosed technology.

### DETAILED DESCRIPTION OF EMBODIMENTS OF THE DISCLOSED TECHNOLOGY

Embodiments of the disclosed technology comprise a portable transceiver device (hereinafter, “device” or “transceiver”), adapted for engagement with an on-board diagnostic port found in a cabin or under the hood of a vehicle. A transceiver, in embodiments of the disclosed technology is defined as an apparatus which is made up of one or more components and is capable of sending and receiving data via radio signal. The transceiver device comprises a satellite receiver to receive data used to determine position (e.g., GPS) and logs such data. The data are stored within a storage medium contained within the device. The device further comprises a wireless network adapter capable of seeking out and connecting to a wireless local area network, such as an 802.11 wireless network, Wi-Fi, WiMAX, or the like network. Upon obtaining network connectivity through a network adapter in the device, such logged data are uploaded to a remote location. Video, audio, or other data may also be logged and uploaded. Furthermore, functions of the vehicle may be toggled using command data sent from a remote location to the device by way of the wireless local area network.

Embodiments of the disclosed technology are described below, with reference to the figures provided.

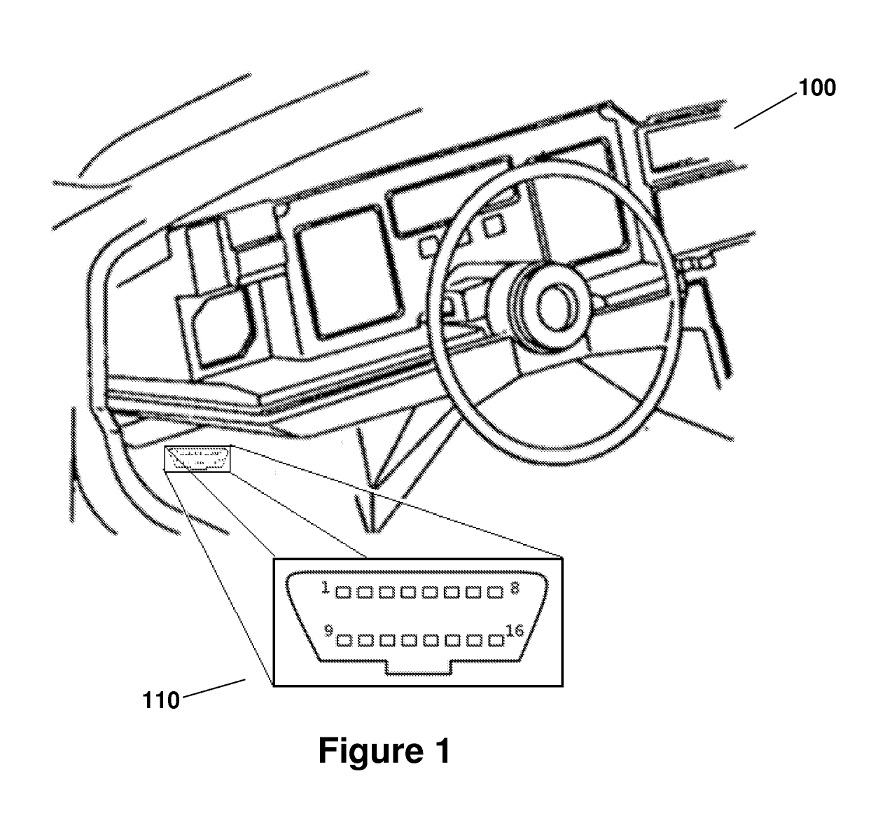

FIG. 1 shows a high level drawing of a vehicle dashboard with an inset of an exemplary on-board diagnostic port. Such devices are used in embodiments of the disclosed technology. The dashboard 100 (or any other area of the vehicle cabin) comprises an on-board diagnostic port 110 which is typically used to plug in a diagnostic device which gathers data from a vehicle's on-board computer. Generally, an OBD interface uses a standardized female 16-pin connector and is typically located under the dashboard on the driver's side of the vehicle. The OBD port may be located in other parts of the vehicle, such as in the engine compartment. However, in embodiments of the disclosed technology, any in-cabin diagnostic interface port known in the art may be used. The transceiver device plugs into the OBD port using a complimentary male connector and is capable of interacting with the vehicle's systems by way of its on-board computer. In order to link the device to an OBD port, the device may use, for example, an SAE (“Society of Automotive Engineers”) J1962 connector, as is known in the art. In embodiments of the disclosed technology, a vehicle's OBD port provides an electrical current through the OBD port sufficient to power the device. The electrical current is constant, even when the vehicle's ignition is turned off.

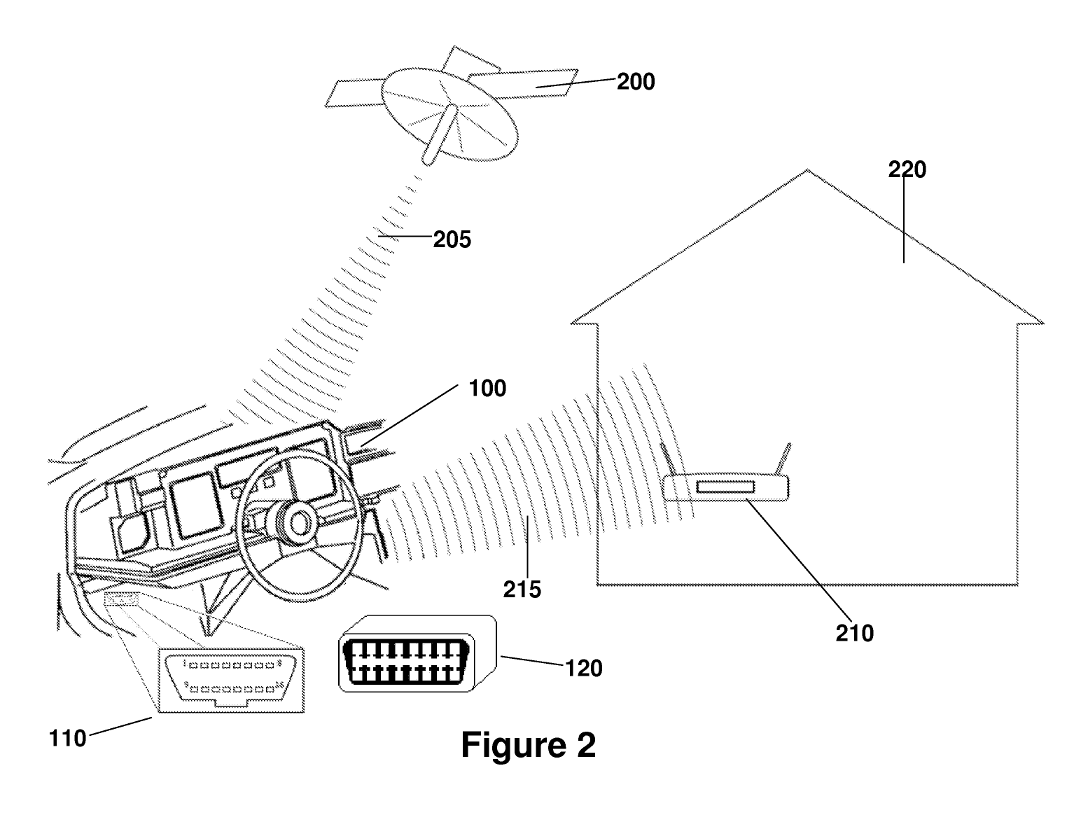

FIG. 2 shows a high level drawing of a global navigation system and network devices used in embodiments of the disclosed technology. A plurality of satellites 200 (only one is shown in FIG. 2), as is known in the art, revolves around the earth and provides location data. Such global navigation systems include the United States Army-funded Global Positioning System (GPS), GLONASS in Russia, Galileo in Europe, and so forth. The transceiver device 120 comprises a global navigation system receiver capable of receiving a navigation signal 205 from a plurality of navigation satellites 200 and determining the position of the device relative to the earth. Such navigation data and/or a relative position of the device are stored on a storage medium within the device 120.

In the embodiment shown in FIG. 2, a wireless local area network router 210, such as an (IEEE) 802.11 specification wireless router, is situated inside a building 220, such as a house, office building, free standing wireless access point, or other structure. A wireless local area network, for the purposes of this specification, is defined as a network with wireless connectivity to a single point of presence or multiple points within a single physical location, such as a building or group of buildings, typically, within a single subnet or block of defined IP addresses for the local area network, and specifically excludes a broader wide area network. It should be understood that the wireless router 210 may be at any location. The wireless router may use substantially any wireless communication schema known in the art, including Bluetooth, 802.11a, 802.11b, 802.11g, 802.11n, Wireless USB, or the like. The device 110 comprises a wireless adapter corresponding to the specific protocol/specification capable of connecting to such a network. In one embodiment, the wireless adapter actively seeks out a data connection with a specific wireless router 210. In another embodiment, a specific wireless network and corresponding data connection are sought based upon a location of the transceiver device (e.g., when near the owner's home, attempt to connect to a first wireless router, or when in a pre-specified city, attempt to connect to a second wireless router or group thereof), or other pre-programmed data. In yet another embodiment, which may be separate or combined with the prior embodiments, an attempt is made to connect with any open wireless network. In another embodiment, a wireless cellular network may be employed instead of a local area network for the purpose of transmitting data to the remote server.

In yet another embodiment, the device may seek out a specific secured available wireless local area network or plurality thereof. In this embodiment, the authentication data necessary to connect to the secured network is stored on the device. Such authentication data typically is in the form of a security key or passphrase. This information may be configured on the device by a user while it is plugged into the vehicle's OBD port or before the device is connected to a vehicle. Such a pre-programming step may take place via wireless or wired data connection with a remote server, and may further include re-programming or configuring the transceiver device once it is in use within a vehicle.

Upon obtaining a wireless connection (negotiating a data connection between a wireless adapter within the device 120 and a wireless router 210), data stored in a storage medium within the device 120 is uploaded to a remote server via the data connection. In this manner, position data is logged, e.g., position data at specific times, and uploaded only as a connection becomes available. In addition, a camera, microphone, or thermometer may interface or form an integral part of the device, so as to allow the device to store video, audio, and thermal data as a function of time. Thus, any one, or a plurality, of position, video, audio, and temperature data as a function of time is uploaded to a remote server upon obtaining a wireless data connection between the device 120 and a network, such as the internet, via wireless router 210. Alternatively, the device may receive and store diagnostic information from the vehicle's on board computer by way of the on board diagnostic port. Such vehicle diagnostic data may include, but is not limited to, gas mileage, oil levels, engine malfunctions, and other measureable vehicle information.

In this manner, a consistent data connection is not necessary, the cost to track vehicle data is greatly reduced, and it is done in a manner which is convenient for the user without requiring protection from the elements and/or a separate power source when using exterior or other interior equipment, and so forth. Moreover, a subscription to a wide area network or cellular phone service is not required. The feeling of invasiveness is also decreased over prior art navigation logging devices and the device is harder to detect because, when a data connection is not active, the wireless data channel is also largely inactive, save attempts to seek out an available network. Still further, in an embodiment of the disclosed technology, the transceiver device may be instructed to only seek out a wireless network at certain hours or after a certain period of time has passed, in order to avoid detection.

Still further, in uses of the disclosed technology, such as after an auto theft, GPS receiver theft, handheld wireless device theft, or other theft, the thief is unlikely to realize that his position, and possibly picture, sound, and when a car door is opened/closed (due to perceivable temperature change or passage of data via the OBD port to the transceiver) is being recorded and sent to a remote server. Furthermore, in one embodiment of the disclosed technology, the device may comprise a backup battery, which will power the device in the event that it becomes disengaged from the vehicle's on-board diagnostic port or power from the OBD port becomes unavailable. Such a feature is beneficial in an instance in which a driver or operator discovers the device and unplugs it. This feature is also useful in the event of an accident in which the trauma from the collision cuts power to the OBD port. The backup battery will provide sufficient power to the device to acquire, store, and possibly transmit the GPS coordinates of the accident location.

In a further method of use of the devices of FIG. 2, a person may use such a device for recreational monitoring of the location and other data related to his vehicle, without any visible evidence of a tracking device, in view of the fact that the device will be securely hidden out of plain view under the dashboard of the vehicle. Additionally, a parent may use such a device 120 to monitor the driving habits of a teen driver, or ensure compliance with coming home at a designated curfew time, or avoiding a certain location. In such an example, upon the car pulling into the driveway or garage of the owner, the device 120 and wireless adapter within it may come into range of a wireless router 210, and thus, via wireless transmission signal 215, data stored on a storage medium within the device 210 is uploaded to a computer of a parent. The parent can then review such data. The teen driver may be aware or unaware that the device 210 is logging. The disclosed technology greatly benefits from the increasing availability of public wireless local area network hot-spots. In another example, a parent may have the device 210 of the disclosed technology configured to connect to any available unsecure wireless local area network. A teen driver in possession of the vehicle may make a stop at a fast-food restaurant or coffee house which provides a free wireless local area network access point. Thus, when the teen drives within range of one of these locations, the device 120 will automatically seek out and connect to the provided wireless local area network. Upon connection, the device 120 will upload the stored data to a remote server. Thereafter, a parent may access this information from his or her home computer at anytime. The type of data uploaded may include, but is not limited to, global positioning coordinates, time, temperature data, video data, sound data, logistical vehicle data, and any other information capable of being gathered through a vehicle's OBD port.

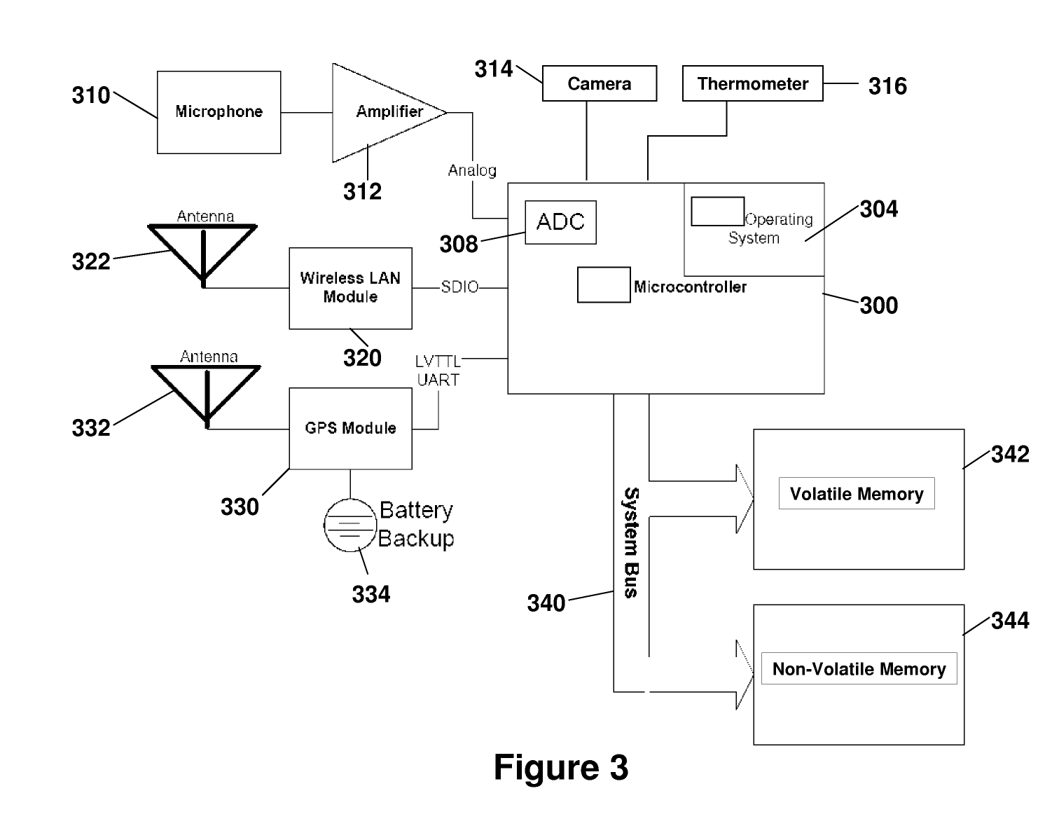

FIG. 3 shows a high level schematic diagram of devices within a transceiver device in an embodiment of the disclosed technology. Various sensory devices (one or a plurality thereof) are used in embodiments of the disclosed technology, including, for example, a microphone 310 operatively (electrically) connected to an amplifier 312, a camera or other video input 314, and a thermometer 316. These components electronically interface with, and are operatively connected to, a central controller or logic circuits of a device, such as a microcontroller 300 running an operating system 304 with an analog-to-digital converter (ADC) 308. The analog-to-digital converter 308 converts a signal received from the microphone 310, or any other analog device, and converts the signal, such as a signal representing recorded sound, into a digital signal for storage on a storage device, such as the volatile memory 342 and/or non-volatile memory 344. The operating system 304 may be any operating system known in the art of microcontrollers, such as Linux and variants thereof. The microcontroller 300, in embodiments of the disclosed technology, is a single integrated circuit having a central processing unit (CPU) combined with support functions, such as a crystal oscillator, timers, watchdog timer, serial and analog I/O or the like. Via a system bus 340, the microcontroller accesses any one or both of volatile memory 342, such as random access memory (RAM) and non-volatile memory (e.g., magnetic disk, flash disk) 344.

Referring still to FIG. 3, an antenna 322 is operatively engaged with a wireless LAN module 320 in embodiments of the disclosed technology. The wireless LAN module is an example of a wireless adapter which can be configured to connect to a wireless network, such as any available wireless network or a specific wireless network. This includes 802.11 networks, Bluetooth networks, wireless USB networks, and so forth, as described above. (As shown in the example of FIG. 3, the wireless LAN module is part of an SDIO [secure digital input output] card which also comprises flash memory.) It is via the wireless LAN module 320 or any other wireless adapter that, in embodiments of the disclosed technology, stored data, such as navigation (location) data, recorded sounds from the microphone 310, recorded pictures or video from the camera 314, and so forth, are uploaded to a remote server, such as a personal computer of an owner or operator of the device.

Still referring to FIG. 3, a GPS module 330 is an example of a satellite navigation system receiver and processor connected to an antenna 332 and having the ability to determine its location based on received satellite data signals. The GPS module 330 (or any other satellite navigation system receiving device), in embodiments of the disclosed technology, is operatively connected to a battery backup 334. The battery backup 334 may be charged when the device receives a flow of electric current from a vehicle battery (e.g., when engaged with an OBD port). Thus, even when the device is not plugged in, position data can continue to be accrued and then uploaded the next time the device receives full power (e.g., is engaged with an OBD port) and connects with a wireless router via the wireless network adapter 320. The backup battery 334, in an embodiment, gives power to the GPS module 330 or other navigation system receiving equipment, to the exclusion of other devices shown and described in FIG. 3. In another embodiment, the backup battery powers the GPS module 330 and microcontroller 300. In yet another embodiment, the backup battery powers the GPS module 330 and microcontroller 300. In yet another embodiment, the backup battery powers all but the sensory devices (microphone, camera, and thermometer, as shown in FIG. 3) and their specialized equipment (e.g., amplifier). In yet another embodiment, the battery backup 334 powers, part or all of the time, the device in its entirety. As such, various power saving modes are available to allow for minimal or maximal data acquisition when input power is unavailable.

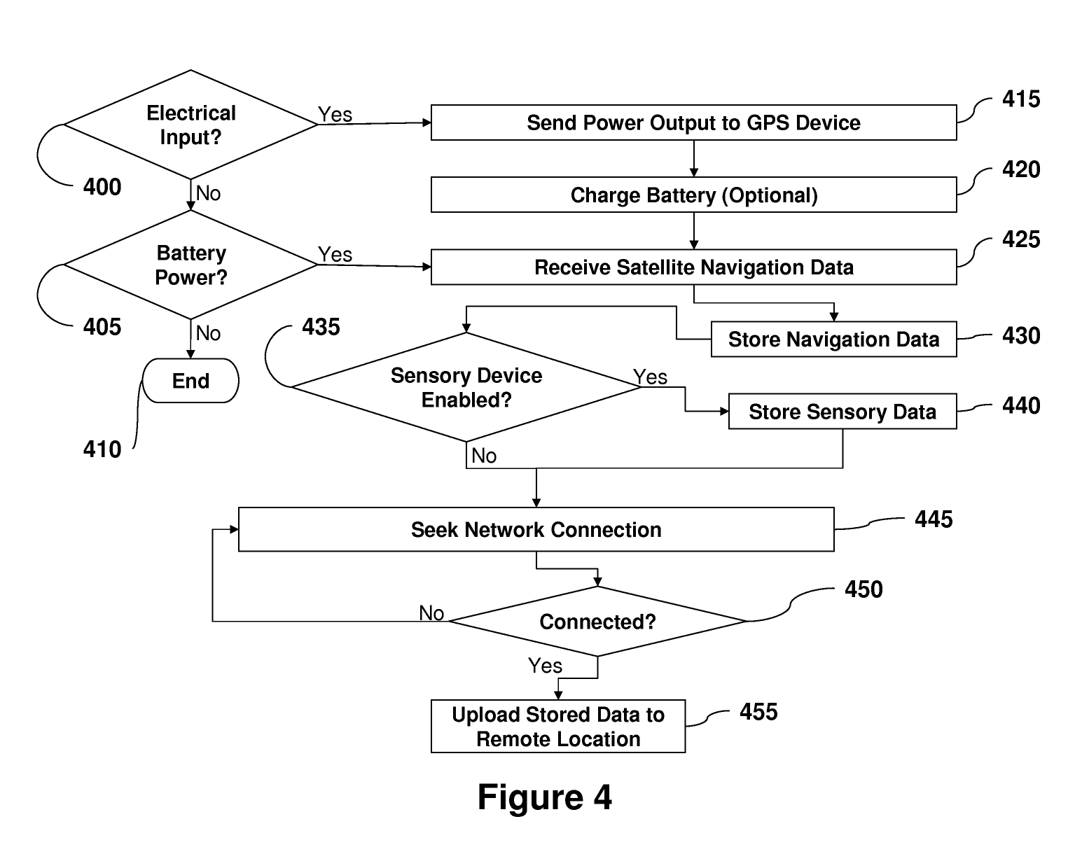

FIG. 4 is a flow chart of a method of carrying out embodiments of the disclosed technology relative to a transceiver device of embodiments of the disclosed technology. In step 400, it is determined if the device is connected to an electrical power source. If the device is properly connected to an OBD (on-board diagnostic) port of a vehicle, than the device will be powered, typically, regardless of whether or not the vehicle is running. If the device is not connected to the OBD port, or the OBD port loses an electrical current for whatever reason, it is determined whether there is (enough) battery power, in step 405, to operate at least the satellite navigation system receiving devices (or any subset of components of the device). If there is not enough current for this, the system goes into a shutdown mode whereby, in step 410, the device powers down. Once there is an electrical input again, the device powers back on. When the electric input is removed, the cycle repeats, regardless of the stage on the flow chart currently being carried out. Step 415 involves the electrical current being used to power the GPS receiver of the device. In embodiments where the device is configured with a battery, in step 420, the battery is charged. If it is fully charged, this step is bypassed. In step 425, satellite navigation system data (e.g., GPS data) is received and a location of the device relative to the earth is discovered (concurrently or via post-processing). The navigation data is then stored, in step 430, on a storage device shown and described with reference to the device-related figures.

In step 435, it is determined whether sensory devices are enabled. They may or may not be enabled due to configuration of a user (e.g., lower power and lower storage requirements without video), configuration of the device itself (e.g., the device may lack a camera so as to lower cost of procurement), power state of the device (e.g., when operating on battery power, the camera may be disabled), or for any other reason (e.g., malfunction of a sensory device). For each enabled sensory device, e.g., camera, microphone, or thermometer, in step 440, after the data is received, it is stored. Steps 400 to 440, in embodiments of the disclosed technology, occur substantially concurrently (whereby ‘substantially’ is defined as within five seconds of each other, or as fast as the device is able to process same under its current load).

Steps 445, 450, and 455 may occur in any order and may occur repeatedly and concurrently with any of the prior steps. In step 445, a connection to a wireless network, such as an 802.11 network, is sought, using, for example, a wireless network adapter built into the device itself. If a connection is made, then step 450 is carried out, whereby the data which has been stored is uploaded to a remote location, such as a computer of the owner on the internet or a server operated by the manufacturer of the device or third party, whereby law enforcement agencies or the owner of the device receive and can view the data. Uploading stored data is defined as a transfer or attempt to transfer at least some of the data stored on a storage device within the device via a network connection.

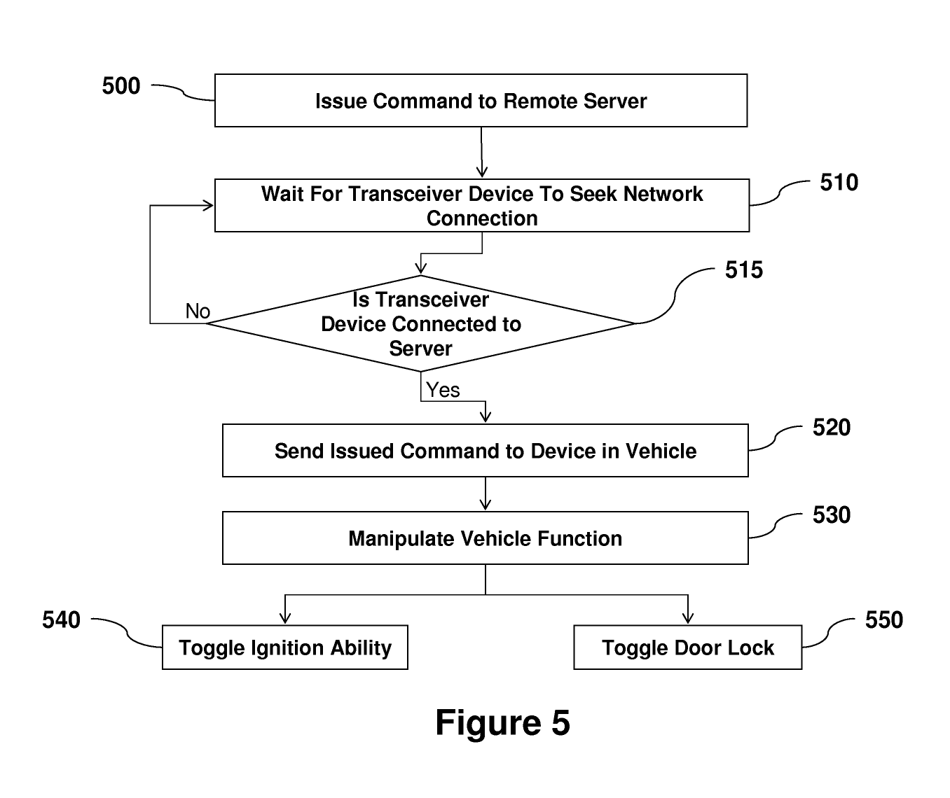

FIG. 5 is a flow chart of a method of carrying out embodiments of the disclosed technology in which a user manipulates a function of a vehicle. The first step, step 500, begins with a remote user accessing the internet via a local area network or a wide area network. Once connected, the user logs onto an interface, such as a program instruction set or software designed to send instructions via a server over a wireless network to the transceiver device. The user may be physically located at the server or may communicate with the server via the internet, a local area network (including the local area network to which the transceiver device connects), or wide area network, as noted above. From this interface, the user sends commands to the in-vehicle device. The commands are stored on the remote server until the device is connected to a local area network. In step 510, the user or a system waits for the device to seek out a connection to a wireless local area network. This step, in embodiments of the disclosed technology, occurs automatically and continuously as long as the device is powered, or as long as it is instructed to do so based on pre-arranged timing, as discussed above. It may occur before, after, or at the same time as step 500. In step 515, it is determined whether a network connection is made between the transceiver device and a server on a local area network. If so, the method proceeds to step 520; if not, the device repeats step 510 until a connection is made. In step 520, the command data is transmitted to the device from the remote server via the wireless local area network connection. The method proceeds with step 530, in which the device uses the command data to manipulate a function of the vehicle. Step 540 shows an embodiment of the disclosed technology in which the ignition ability is toggled by the user. Step 550 shows another embodiment of the disclosed technology in which the door lock function of the vehicle is toggled. Steps 540 and 550 merely represent two embodiments exemplifying a vehicle's functions being manipulated by user-sent command data. It should be understood by one skilled in the art that other vehicle functions may be manipulated to the extent that the device's and OBD port's capabilities allow.

An illustrative example of a method of an embodiment of the disclosed technology, according to FIG. 5, is when a user realizes his/her vehicle has been stolen. In such a case, the user logs onto an interface and issues a command to the remote server (step 500) to disable the ignition ability of the vehicle. The remote server then sends the issued command to the transceiver device in the vehicle (step 510) if the device is, or upon the device becoming, connected to a wireless local area network. The device then communicates the command data to the vehicle's on-board computer (step 520) to manipulate a vehicle function (step 530), which, in this example, is a disabling of the ignition function or ability (step 540).

In another example of same, a user may actually find his stolen car, connect to the transceiver device using a WiFi enabled (e.g., 802.11) device (steps 510 and 515), and disable the ignition (step 540) or toggle another feature of the car (step 530). In this manner, the car can be disabled, until the police can arrive, or the car is placed under surveillance in order that the thief or operator of the stolen vehicle can be identified and/or apprehended. In yet another (similar) embodiment, a user who finds his or her car, but had locked his or her keys in the car, can connect wirelessly to the remote transceiver device and unlock the car doors.

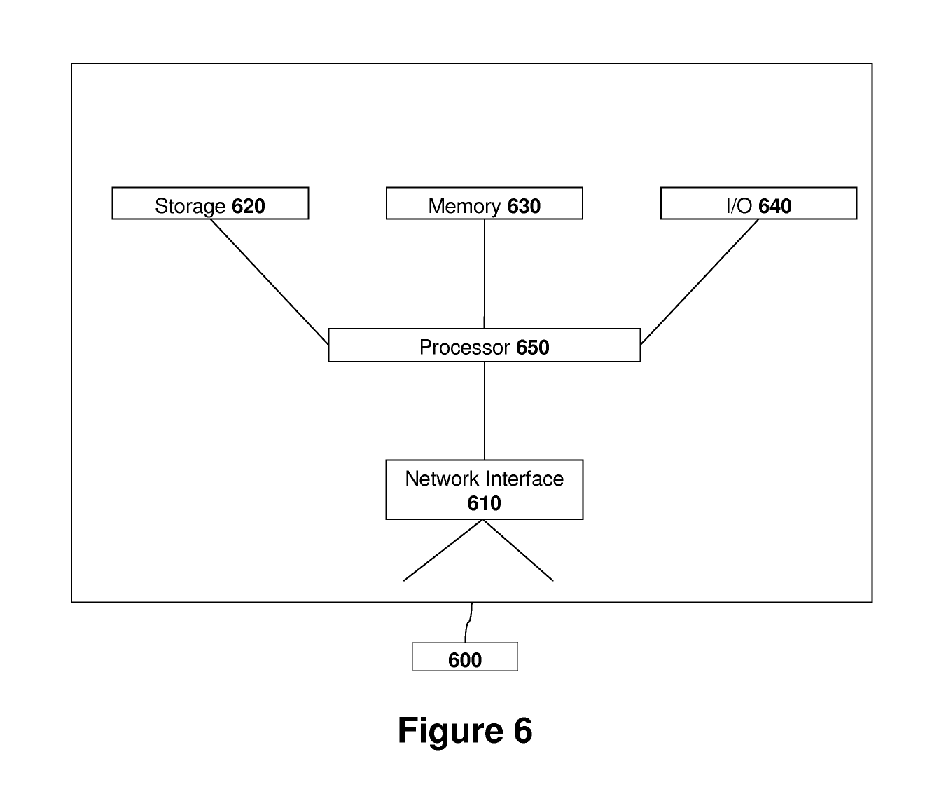

FIG. 6 shows a high-level block diagram of a device that may be used to carry out the disclosed technology. Device 600 comprises a processor 650 that controls the overall operation of the computer by executing the device's program instructions which define such operation. The device's program instructions may be stored in a storage device 620 (e.g., magnetic disk, database) and loaded into memory 630 when execution of the console's program instructions is desired. Thus, the device's operation will be defined by the device's program instructions stored in memory 630 and/or storage 620, and the console will be controlled by processor 650 executing the console's program instructions. A device 600 also includes one or a plurality of input network interfaces for communicating with other devices via a network (e.g., the internet). The device 600 further includes an electrical input interface for receiving power and data from a vehicle's OBD port or a battery source. A device 600 also includes one or more output network interfaces 610 for communicating with other devices. Device 600 also includes input/output 640 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 5 may be implemented on a device such as is shown in FIG. 6.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A transceiver device comprising:
an interface adapted for engagement with an on-board diagnostic port of a vehicle;
a global navigation satellite system receiver;
a data storage device for storing received global navigation system data from said global navigation satellite system receiver; and
a wireless network adapter configured to seek out and connect to an available wireless local area network, and upload data stored in said data storage device to a remote server upon connection to an available said wireless local area network.

2. The transceiver device of claim 1, wherein said seeking out of said available wireless network comprises seeking out of an unsecured 802.11 wireless network.

3. The transceiver device of claim 1, wherein said seeking out of a said available wireless network comprises seeking out of pre-programmed wireless local area networks that are pre-programmed into said device.

4. The transceiver device of claim 3, wherein a said pre-programmed wireless area network is a secure network, and data to authenticate access to said secure and available wireless local area network is stored on said device.

5. The transceiver device of claim 1, wherein said transceiver device manipulates a function of said vehicle through said on-board diagnostic port based on command data received by way of said wireless local area network.

6. The transceiver device of claim 5, wherein said function comprises toggling ignition ability of said vehicle.

7. The transceiver device of claim 5, wherein said function comprises toggling a state of a door lock in said vehicle.

8. The transceiver device of claim 1, wherein said remote server is located on said wireless local area network.

9. The transceiver device of claim 1, wherein said remote server is located on a wide area network, and said uploaded data is transmitted to said remote server through an open, public packet-switched network.

10. The transceiver device of claim 1, further comprising at least one sensory input device configured to record to said data storage device sensory information within a cabin of said vehicle.

11. The device transceiver of claim 10, wherein said sensory input device is selected from the group consisting of microphones, cameras, and thermometers.

12. A method of remotely communicating with a vehicle comprising the following the steps:
providing a transceiver device comprising:
a global navigation satellite system receiver,
a non-volatile storage device,
a connector adapted for connection with an on-board diagnostic port of said vehicle, and
a wireless network adapter;
connecting said transceiver device via said connector to said on board diagnostic port of a vehicle;
instructing said transceiver device to receive global navigation system data via said global navigation satellite system receiver;
instructing said transceiver device to store said global navigation system data to said storage device; and
configuring said transceiver device to connect to any one of a plurality of wireless local area networks and upload data stored on said storage device to a remote server via a said wireless local area network.

13. The method of claim 12, further comprising a step of manipulating a function of said vehicle by way of said transceiver device and said remote server.

14. The method of claim 13, wherein said function is an ignition system of said vehicle.

15. The method of claim 13, wherein said function is a door lock of said vehicle.

16. The method of claim 12, wherein said transceiver device further comprises a microphone, and said transceiver stores sound data on said storage device, and said sound data is uploaded to said remote server.

17. The method of claim 12, wherein said transceiver device further comprises a camera, said transceiver device stores video data on said storage device, and said video data is uploaded to said remote server.

18. The method of claim 12, wherein said wireless local area network is an 802.11 wireless network.

19. The method of claim 18, wherein said 802.11 wireless network is unsecured.

20. The method of claim 18, wherein said 802.11 wireless network is a secure wireless network, and data used for authenticating a connection to said network is stored on said storage device before said step of connecting.

21. A transceiver device comprising:
an interface adapted for engagement with an on-board diagnostic port of a vehicle;
a global navigation satellite system receiver;
a data storage device for storing received global navigation system data from said global navigation satellite system receiver;
at least one sensory input device, configured to record to said data storage device, sensory information from said vehicle; and
a wireless network adapter configured to seek out and connect to an available wireless network, and upload data stored in said data storage device to a remote server upon connection to an available said wireless network.

22. The device transceiver of claim 21, wherein said sensory input device captures at least one data type selected from the group consisting of sound data, video data, temperature data, and vehicle diagnostic data.

23. The transceiver device of claim 22, wherein said seeking out of a said wireless network comprises seeking out of pre-programmed wireless networks that are pre-programmed into said device.

24. The transceiver device of claim 22, wherein said transceiver device manipulates a function of said vehicle through said on-board diagnostic port based on command data received by way of said wireless network.

25. The transceiver device of claim 24, wherein said function comprises toggling ignition ability of said vehicle.

26. The transceiver device of claim 24, wherein said function comprises toggling a state of a door lock in said vehicle.

27. The transceiver device of claim 22, wherein said remote server is located on said wireless network.

28. The transceiver device of claim 22, wherein said remote server is located on a wide area network, and said uploaded data is transmitted to said remote server through an open, public packet-switched network.
